(19) United States
(12) Patent Application Publication
(10) Pub. No.: US 2022/0009371 A1
(43) Pub. Date: Jan. 13, 2022

(54) CELL ASSEMBLY, INTELLIGENT BATTERY, AND UNMANNED AERIAL VEHICLE

(71) Applicant: SZ DJI TECHNOLOGY CO., LTD., Shenzhen (CN)

(72) Inventors: Caihui ZHANG, Shenzhen (CN); Peng LI, Shenzhen (CN)

(73) Assignee: SZ DJI TECHNOLOGY CO., LTD., Shenzhen (CN)

(21) Appl. No.: 17/486,928

(22) Filed: Sep. 28, 2021

Related U.S. Application Data
(63) Continuation of application No. PCT/CN2019/080133, filed on Mar. 28, 2019.

(51) Int. Cl. B60L 53/65; B60L 53/80; H02J 7/00; B64C 39/02

(52) U.S. Cl. CPC B60L 53/65; B60L 53/80; B64C 2201/042; B64C 39/024; H02J 7/00045

(57) ABSTRACT

A cell assembly, an intelligent battery, and an unmanned aerial vehicle are provided. The cell assembly includes at least one cell bodies and at least one encryption circuit. The cell body is a smallest power supply unit, and the encryption circuit stores feature information of the cell body. The encryption circuit is directly or indirectly coupled to the cell body to form an independent unit, and the independent unit may be mechanically detachably and/or electrically connected to an external device. When the independent unit is electrically connected to the external device, the encryption circuit may send the feature information of the cell body to the external device, to identify whether the cell assembly is matchable and useable with the external device. Therefore, high-voltage and large-capacity intelligent batteries where cells are usually connected in series and/or in parallel are prevented from being counterfeited, and safety of the batteries is improved.

### RELATED APPLICATIONS

This application is a continuation application of PCT application No. PCT/CN2019/080133, filed on Mar. 28, 2019, and the content of which is incorporated herein by reference in its entirety.

### TECHNICAL FIELD

Exemplary embodiments of the present disclosure relate to the technical field of electronic devices, and in particular, to a cell assembly, an intelligent battery, and an unmanned aerial vehicle.

### BACKGROUND

In recent years, use of intelligent batteries has gradually become popular in the unmanned aerial vehicle industry, and in particular, in the agricultural unmanned aerial vehicle industry. A battery can provide power for an agricultural unmanned aerial vehicle for flying and support the agricultural unmanned aerial vehicle in implementing various tasks. However, quality of the battery directly affects user experience of the agricultural unmanned aerial vehicle. Because the agricultural unmanned aerial vehicle itself is large in size and carries a lot of objects, the corresponding agricultural unmanned aerial vehicle battery has a high voltage and a large capacity, and has a plurality of cells connected in series or in parallel. Usually, the agricultural unmanned aerial vehicle battery is composed of several cells and equipped with a battery protection board (Battery Management System board, or BMS board). These components are packaged as a whole for normal use of the agricultural unmanned aerial vehicle. To ensure product quality and flight safety of agricultural unmanned aerial vehicles, an agricultural unmanned aerial vehicle manufacturer encrypts its intelligent batteries for protection purposes, to prevent counterfeit battery manufacturers from producing inferior batteries and applying such batteries to agricultural unmanned aerial vehicles produced by the agricultural unmanned aerial vehicle manufacturer. In this way, a failure rate or explode rate of the agricultural unmanned aerial vehicles may be effectively reduced.

A conventional battery encryption method is to directly perform an authentication algorithm on a battery protection board or to perform cryptographic authentication with an unmanned aerial vehicle by using an encryption chip on a battery protection board. Although this method prevents some intelligent batteries of unmanned aerial vehicles from being counterfeited, high-voltage and large-capacity agricultural unmanned aerial vehicle batteries having a plurality of cells connected in series or in parallel still cannot be prevented from being counterfeited. Therefore, there still are great safety hazards, and there is a need for a more securely encrypted agricultural unmanned aerial vehicle intelligent battery.

### BRIEF SUMMARY

An objective of the present disclosure is to resolve at least one technical problem in the existing battery encryption technology due to an authentication algorithm is directly performed on a battery protection board or cryptographic authentication is performed with an unmanned aerial vehicle by using an encryption chip on a battery protection board. High-voltage and large-capacity unmanned aerial vehicle batteries having a plurality of cells connected in series or in parallel are easily counterfeited and may cause great safety hazards.

In some exemplary embodiments of the present disclosure, a cell assembly is provided. The cell assembly includes: at least one cell body; and at least one encryption circuit storing feature information of the at least one cell body and directly or indirectly coupled to the at least one cell body to form an independent unit, where the independent unit is mechanically and detachably connectable to an external device, and when the independent unit is electrically connected to the external device, the at least one encryption circuit is configured to send the feature information of the at least one cell body to the external device, to determine whether the at least one cell assembly is matchable and useable with the external device.

In some exemplary embodiments of the present disclosure, an intelligent battery is provided. The intelligent battery includes: a housing; a battery management system mounted in the housing; and a cell assembly mounted in the housing, including: at least one cell body, and at least one encryption circuit storing feature information of the cell body and directly or indirectly coupled to the at least one cell body to form an independent unit, where the independent unit is mechanically and detachably connectable to the battery management system; when the independent unit is electrically connected to the battery management system, the battery management system is communicatively connectable to both the at least one encryption circuit and an external device, and the at least one encryption circuit is configured to send the feature information of the at least one cell body to the external device to perform communication authentication for the cell assembly, to determine whether the cell assembly is matchable and usable with the external device.

In some exemplary embodiments of the present disclosure, an unmanned aerial vehicle is provided. The unmanned aerial vehicle includes: a main body; a propulsion system, mounted on the main body to supply power to the unmanned aerial vehicle; and an intelligent battery disposed in the main body, including: a housing; a battery management system mounted in the housing; and a cell assembly mounted in the housing, including: at least one cell body, and at least one encryption circuit storing feature information of the cell body and directly or indirectly coupled to the at least one cell body to form an independent unit, where the independent unit is mechanically and detachably connectable to the battery management system; when the independent unit is electrically connected to the battery management system, the battery management system is communicatively connectable to both the at least one encryption circuit and an external device, and the at least one encryption circuit is configured to send the feature information of the at least one cell body to the external device to perform communication authentication for the cell assembly, to determine whether the cell assembly is matchable and usable with the external device; where the intelligent battery is electrically connected to the propulsion system to supply power to the propulsion system.

It may be seen from the technical solutions provided by the foregoing exemplary embodiments of the present disclosure that counterfeiting of high-voltage and large-capacity batteries having a plurality of cells connected in series or in parallel may be effectively reduced or even eliminated according to the cell assembly, intelligent battery, and unmanned aerial vehicle provided by the exemplary embodiments of the present disclosure. Use of unauthenticated intelligent batteries may be avoided, and safety and reliability of intelligent batteries may be ensured. In this way, quality and performance of the intelligent batteries may be ensured, and safety of the batteries and unmanned aerial vehicles in use may be greatly improved.

### BRIEF DESCRIPTION OF THE DRAWINGS

To clearly describe the technical solutions in the exemplary embodiments of the present disclosure, the following briefly describes the accompanying drawings required for describing the exemplary embodiments. Apparently, the accompanying drawings in the following description show some exemplary embodiments of the present disclosure, and a person of ordinary skill in the art may still derive other drawings from these accompanying drawings without creative efforts, which shall all fall within the scope of protection of the present disclosure.

FIG. 1 is a structural block diagram of a cell assembly according to some exemplary embodiments of the present disclosure;

FIG. 2 is a perspective view of a cell assembly according to some exemplary embodiments of the present disclosure;

FIG. 3 is a structural block diagram of an intelligent battery according to some exemplary embodiments of the present disclosure;

FIG. 4 is an exploded view of an intelligent battery according to some exemplary embodiments of the present disclosure;

FIG. 5 is a perspective view of an intelligent battery according to some exemplary embodiments of the present disclosure;

FIG. 6 is a structural block diagram of an unmanned aerial vehicle according to some exemplary embodiments of the present disclosure; and

FIG. 7 is a perspective view of an agricultural unmanned aerial vehicle according to some exemplary embodiments of the present disclosure.

10. cell assembly; 11. cell body; 12. encryption circuit; 100. intelligent battery; 110. cell assembly; 111. cell body; 112. encryption circuit; 120. battery management system; 130. housing; 1000. unmanned aerial vehicle; 1100. intelligent battery; 1110. cell assembly; 1111. cell body; 1112. encryption circuit; 1120. battery management system; 1200. propulsion system; and 1300. flight control system.

### DETAILED DESCRIPTION

To clearly describe the objectives, technical solutions, and advantages of the exemplary embodiments of the present disclosure, the following clearly describes the technical solutions in the exemplary embodiments of the present disclosure with reference to the accompanying drawings in the exemplary embodiments of the present disclosure. Apparently, the described exemplary embodiments are some rather than all of the exemplary embodiments of the present disclosure. All other embodiments obtained by a person of ordinary skill in the art based on the exemplary embodiments of the present disclosure without creative efforts shall fall within the protection scope of the present disclosure.

A conventional battery encryption method is to directly perform an authentication algorithm on a battery protection board or to perform cryptographic authentication with an unmanned aerial vehicle by using an encryption chip on a battery protection board. Although this method prevents some intelligent batteries of unmanned aerial vehicles from being counterfeited, high-voltage and large-capacity agricultural unmanned aerial vehicle batteries having a plurality of cells connected in series or in parallel still cannot be prevented from being counterfeited. Therefore, there still are great safety hazards. Once the batteries having safety hazards are used in an unmanned aerial vehicle, the unmanned aerial vehicle may not fly normally or may have difficulty in flying, and more severely, the unmanned aerial vehicle may cause damage to buildings, crops, animals, and people.

To resolve the foregoing technical problem, the present disclosure provides a plurality of technical solutions such as a cell assembly, an intelligent battery, and an unmanned aerial vehicle. The following describes the cell assembly, the intelligent battery, and the unmanned aerial vehicle in the present disclosure in detail with reference to accompanying drawings. In absence of conflicts, the following exemplary embodiments and features may be mutually combined.

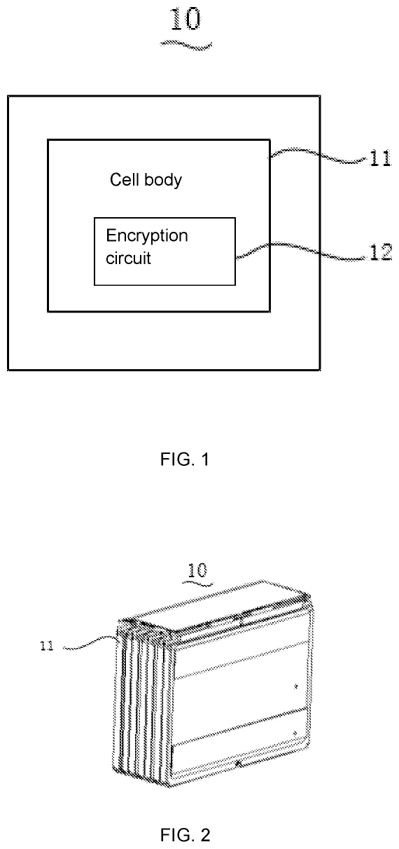

Referring to FIG. 1 and FIG. 2, in some exemplary embodiments of the present disclosure, a cell assembly 10 is provided, where the cell assembly 10 may include a cell body 11 and an encryption circuit 12.

The cell body 11 may include at least one cell bodies, and each cell body 11 may be used as a smallest power supply unit.

The encryption circuit 12 may include at least one encryption circuits, and each encryption circuit 12 may store feature information of the cell body 11.

The encryption circuit 12 may be coupled to the cell body 11. In some exemplary embodiments of the present disclosure, the encryption circuit 12 may be directly coupled to the cell body 11, that is, the encryption circuit 12 may be directly attached to the cell body 11. Alternatively, in some exemplary embodiments of the present disclosure, the encryption circuit 12 may be indirectly coupled to the cell body 11, that is, the encryption circuit 12 may be coupled to the cell body 11 by a connection line or other connection forms.

The cell body 11 may be coupled to the encryption circuit 12 in the foregoing manner, so that the cell assembly 10 may form an independent unit, the independent unit may be mechanically detachably connected to an external device, the independent unit may be electrically connected to the external device, or the independent unit may be both mechanically detachably and electrically connected to the external device. When the independent unit is electrically connected to the external device, the encryption circuit 12 may send the feature information of the cell body 11 to the external device, to identify whether the cell assembly 10 is matchable and useable with the external device.

In some exemplary embodiments of the present disclosure referring to FIG. 2, the cell body 11 and the encryption circuit (not shown in FIG. 2) may form one cell assembly 10. The cell assembly 10 may further include at least one tab plate (not shown in FIG. 2), where the at least one tab plate may be electrically connected to the cell body 11, and the cell body 11 may supply power externally through the at least one tab plate. The encryption circuit 12 may be electrically connected to the at least one tab plate, and may send the feature information of the cell body 11 to the external device through the at least one tab plate.

In some exemplary embodiments of the present disclosure, the coupling mode between the encryption circuit 12 and the cell body 11 may be indirect coupling. In this case, the encryption circuit 12 may be disposed on the at least one tab plate. Further, the encryption circuit 12 may be embedded in the at least one tab plate, or may be directly mounted on a surface of the at least one tab plate.

In some exemplary embodiments of the present disclosure, the encryption circuit 12 may be directly coupled to the cell body 11. In this case, the encryption circuit 12 may be directly disposed on the cell body 11. In some exemplary embodiments of the present disclosure, the encryption circuit 12 may be directly disposed in the cell body 11. The direct coupling mode between the encryption circuit 12 and the cell body 11 is not limited herein. In some exemplary embodiments of the present disclosure, the encryption circuit 12 may be directly mounted on a surface of the cell body 11, in some non-limiting examples, attached to the surface of the cell body 11.

In some exemplary embodiments of the present disclosure, a quantity of encryption circuits 12 may be the same as a quantity of cell assemblies 10. In some non-limiting examples, one cell assembly 10 may include only one encryption circuit 12. In this case, a quantity of cell bodies 11 may be one or more. In some exemplary embodiments of the present disclosure, a quantity of encryption circuits 12 may be the same as a quantity of cell bodies 11. In some no-limiting examples, each cell assembly 10 may include a plurality of cell bodies 11 and a plurality of encryption circuits 12, that is, one encryption circuit 12 may be disposed on each cell body 11.

In some exemplary embodiments of the present disclosure, the encryption circuit 12 may be in a plurality of forms, and is not limited to a specific form. An encryption circuit 12 in any form may be matchable and usable with the cell body 11. For example, the encryption circuit 12 may be an encryption chip, where a physical form of the encryption chip may be the same as a physical form of a conventional encryption chip, and the encryption chip may be directly coupled to the cell body 11 or may be indirectly coupled to the cell body 11 in other manners. In some exemplary embodiments of the present disclosure, the encryption circuit 12 may also be a micro control unit supporting an encryption algorithm, where a physical form of the micro control unit may be similar to that of the encryption chip, and the micro control unit may support the encryption algorithm. Both the encryption chip and the micro control unit in some exemplary embodiments of the present disclosure may store the feature information of the cell body 11.

In some exemplary embodiments of the present disclosure, the encryption chip may be communicatively connected to the external device. The communication connection may be in a plurality of forms. For example, a single-wire communication connection may be used between the encryption chip and the external device. Certainly, a two-wire serial bus connection (that is, I2C serial communication bus) may also be used between the encryption chip and the external device. When a two-wire serial bus communication connection is used between the encryption chip and the external device, only a data line and a clock line may be required. A bus interface may be integrated in the encryption chip and no special interface circuit may be required. That is, the feature information of the cell body 11 may be transmitted between the devices connected to the bus.

In some exemplary embodiments of the present disclosure, the feature information of the cell body 11 may be classified into asymmetric encryption information and symmetric encryption information. Both asymmetric encryption information and symmetric encryption information may be used. In some exemplary embodiments of the present disclosure, the feature information may be asymmetric encryption information. In some exemplary embodiments of the present disclosure, the encryption chip may communicate with the external device through a two-wire serial bus communication connection or a single-wire communication connection, use an asymmetric public key or private key verification protocol to ensure security of the feature information, and provide different keys based on an elliptic curve cryptography algorithm (ECC) for encryption and decryption, to complete cryptographic authentication and identification with the external device.

In some exemplary embodiments of the present disclosure, the feature information may include electrical parameter information of the cell body 11. Further, the electrical parameter information may include a full charging voltage of a battery, a full charging capacity, a quantity of cycles, a platform voltage, a pack manufacturer, a running status parameter, or the like, or any combination thereof. Certainly, other information related to electrical parameters may also be included. Details are not described again herein.

In some exemplary embodiments of the present disclosure, a connection mode of the cell body 11 may be designed based on needs. When a high-voltage battery is required, a plurality of cell bodies 11 may be selected and connected in series; when a larger capacity and a larger current are required, a plurality of cell bodies 11 may be selected and connected in parallel; or when the foregoing conditions need to be considered comprehensively, a combination of connecting in series and connecting in parallel, that is, a serial-parallel connection may also be used for the cell bodies 11. Details are not specifically limited herein.

In some exemplary embodiments of the present disclosure, the cell assembly 10 may further include a covering part, where both the cell body 11 and the encryption circuit 12 may be mounted in the covering part. In some exemplary embodiments of the present disclosure, the covering part may be a hard housing or a soft bag.

In some exemplary embodiments of the present disclosure, the cell assembly 10 may further include a first electrical connection interface, where the cell assembly 10 may be electrically connected to the external device by using the electrical connection interface. In some exemplary embodiments of the present disclosure, the encryption circuit 12 may transmit the feature information of the cell body 11 through the first electrical connection interface. The cell body 11 may also supply power through the first electrical connection interface. Further, when the first electrical connection interface is configured to transmit feature information, the first electrical connection interface may be a communications interface; or when the first electrical connection interface is configured to supply power, the first electrical connection interface may be a power interface. Still further, the external device may be further provided with a second electrical connection interface, where the second electrical connection interface may be configured to cooperate with the first electrical connection interface.

In some exemplary embodiments of the present disclosure, the external device may be a battery management system (BMS). In some exemplary embodiments of the present disclosure, the external device may be an unmanned aerial vehicle. When the external device is a battery management system, a physical form of the battery management system may be a battery protection board externally covering the cell assembly 10. The encryption circuit 12 may be communicatively connected to the battery protection board. The encryption circuit 12 may send the stored feature information of the cell body 11 to the battery protection board. In this case, the battery protection board may identify and authenticate the cell assembly 10, and if the authentication succeeds, it indicates that the cell assembly 10 may be matchable and usable with the external device. In this case, quality of the cell assembly 10 may be ensured. If the authentication fails, it indicates that the cell assembly 10 may not be matchable and usable. In this case, the cell assembly 10 is non-original or is not a cell assembly manufactured by an original manufacturer. In some exemplary embodiments of the present disclosure, the external device may be an unmanned aerial vehicle. In some exemplary embodiments of the present disclosure, the unmanned aerial vehicle may be an unmanned aerial vehicle for agricultural plant protection.

In daily use, a user normally encounters a whole battery. In another word, the user does not encounter battery parts. In some exemplary embodiments of the present disclosure, at least one cell assemblies and a battery management system may form an intelligent battery. In this case, the intelligent battery may be used by the user in various apparatuses that need to be powered. As an independent unit, the cell assembly may be generally produced as a whole during production, or may be replaced as a whole in a battery during maintenance. Therefore, the cell assembly is an important part of the battery, and the cell assembly may also be produced, maintained or replaced independently of the battery itself.

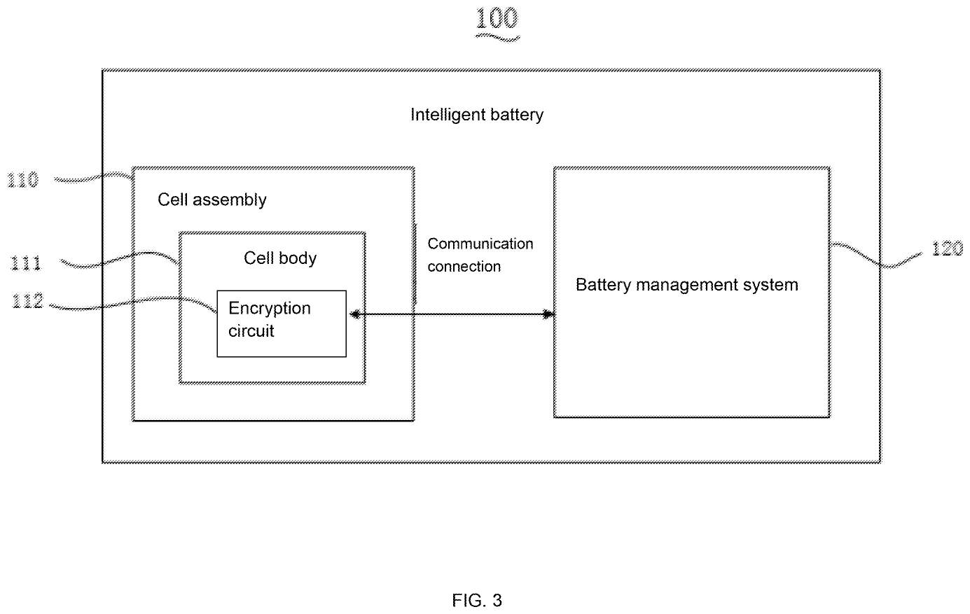

In some exemplary embodiments of the present disclosure referring to FIG. 3 to FIG. 5, an intelligent battery is provided, where the intelligent battery 100 may include a cell assembly 110, a battery management system 120, and a housing 130. The cell assembly 110 may be mounted in the housing 130. The battery management system 120 may also be mounted in the housing 130 and may be electrically connected to the cell assembly 110. The cell assembly 110 may be the cell assembly in some exemplary embodiments of the present disclosure.

In some exemplary embodiments of the present disclosure referring to FIG. 3, a communication connection may be established between the cell assembly 110 and the battery management system 120. The cell assembly 110 may include a cell body 111 and an encryption circuit 112. The cell body 111 may be a smallest power supply unit, and the encryption circuit 112 may store feature information of the cell body 111. The encryption circuit 112 may be directly coupled to the cell body 111. In some exemplary embodiments of the present disclosure, the encryption circuit 112 may be directly attached to the cell body 111. Alternatively, the encryption circuit 112 may be indirectly coupled to the cell body 111. In some exemplary embodiments of the present disclosure, the encryption circuit 112 may be coupled to the cell body 111 by using a connection line or another connection form. The cell body 111 may be coupled to the encryption circuit 112 in the foregoing manner, so that the cell assembly 110 may form an independent unit, the independent unit may be mechanically detachably connected to an external device, the independent unit may be electrically connected to the external device, or the independent unity may be both mechanically detachably and electrically connected to the external device. In some exemplary embodiments of the present disclosure, when the independent unit is electrically connected to the battery management system 120, the battery management system 120 may be communicatively connected to both the encryption circuit 112 and the external device, and the encryption circuit 112 may send the feature information of the cell body 111 to the external device, so that the external device may perform communication authentication for the cell assembly 110, to identify whether the cell assembly 110 may be matchable and usable with the external device.

In some exemplary embodiments of the present disclosure, the cell assembly 110 may further include at least one tab plate, where the at least one tab plate may be electrically connected to the cell body 111, and the cell body 111 may supply power externally through the at least one tab plate. The encryption circuit 112 may be electrically connected to the at least one tab plate, and may send the feature information of the cell body 111 to the external device through the at least one tab plate.

In some exemplary embodiments of the present disclosure, the encryption circuit 112 may be indirectly coupled to the cell body 111. In this case, the encryption circuit 112 may be disposed on the at least one tab plate. Further, the encryption circuit 112 may be directly embedded in the at least one tab plate, or may be directly attached to a surface of the at least one tab plate.

In some exemplary embodiments of the present disclosure, the encryption circuit 112 may be directly coupled to the cell body 111. In this case, the encryption circuit 112 may be directly disposed on the cell body 111. Further, the encryption circuit 112 may be directly mounted on a surface of the cell body 111, in some non-limiting examples, attached to the surface of the cell body 111, or may be embedded in the cell body 111.

In some exemplary embodiments of the present disclosure, a quantity of encryption circuits 112 may be the same as a quantity of cell assemblies 110. In some non-limiting examples, one cell assembly 110 may include only one encryption circuit 112. In this case, a quantity of cell bodies 111 may be one or more. In some exemplary embodiments of the present disclosure, a quantity of encryption circuits 112 may be the same as a quantity of cell bodies 111. In some non-limiting examples, each cell assembly 110 may include a plurality of cell bodies 111 and a plurality of encryption circuits 112, that is, one encryption circuit 112 may be disposed on each cell body 111.

In some exemplary embodiments of the present disclosure, the encryption circuit 112 may be in a plurality of forms, and is not limited to a specific form. The encryption circuit 112 may be an encryption chip, or may be a micro control unit supporting an encryption algorithm. Both the encryption chip and the micro control unit in some exemplary embodiments of the present disclosure may store the feature information of the cell body 111.

Further, the encryption chip may be communicatively connected to the external device. The communication connection may be in a plurality of forms. In some exemplary embodiments of the present disclosure, a single-wire communication connection may be used between the encryption chip and the external device. In some exemplary embodiments of the present disclosure, a two-wire serial bus connection (that is, I2C serial communication bus) may be used between the encryption chip and the external device. When a two-wire serial bus communication connection is used between the encryption chip and the external device, only a data line and a clock line may be required. A bus interface may be integrated in the encryption chip and no special interface circuit is required. That is, the feature information of the cell body 111 may be transmitted between the devices connected to the bus.

In some exemplary embodiments of the present disclosure, the feature information of the cell body 111 may be classified into asymmetric encryption information and symmetric encryption information. Both asymmetric encryption information and symmetric encryption information may be used. In some exemplary embodiments of the present disclosure, the feature information may be asymmetric encryption information. The encryption chip may communicate with the external device through a two-wire serial bus communication connection or a single-wire communication connection, use an asymmetric public key or private key verification protocol to ensure security of the feature information, and provide different keys based on an elliptic curve cryptography algorithm (ECC) for encryption and decryption, to complete cryptographic authentication and identification with the external device.

In some exemplary embodiments of the present disclosure, the feature information may include electrical parameter information of the cell body 111. The electrical parameter information may include a full charging voltage of a battery, a full charging capacity, a quantity of cycles, a platform voltage, a pack manufacturer, a running status parameter, or the like, or any combination thereof. Certainly, other information related to electrical parameters may also be included. Details are not described again herein.

There may be a plurality of connection modes for the cell body 111. In some exemplary embodiments of the present disclosure, when a high-voltage battery is required, a plurality of cell bodies 111 may be selected and connected in series; when a larger capacity and a larger current are required, a plurality of cell bodies 111 may be selected and connected in parallel; or when the foregoing conditions need to be considered comprehensively, a combination of connecting in series and connecting in parallel, that is, a serial-parallel connection, may also be used for the cell bodies 111. Details are not specifically limited herein. A selection may be made based on needs.

In some exemplary embodiments of the present disclosure, the cell assembly 110 may further include a covering part, where both the cell body 111 and the encryption circuit 112 may be mounted in the covering part. The covering part may be a hard housing or a soft bag.

In some exemplary embodiments of the present disclosure, the cell assembly 110 may further include a first electrical connection interface, where the cell assembly 110 may be electrically connected to the external device by using the electrical connection interface. In some exemplary embodiments of the present disclosure, the encryption circuit 112 may transmit the feature information of the cell body 111 through the first electrical connection interface. The cell body 111 may also supply power through the first electrical connection interface. Further, when the first electrical connection interface is configured to transmit feature information, the first electrical connection interface may be a communications interface; or when the first electrical connection interface is configured to supply power, the first electrical connection interface may be a power interface. Still further, the external device may be further provided with a second electrical connection interface, where the second electrical connection interface may be configured to cooperate with the first electrical connection interface.

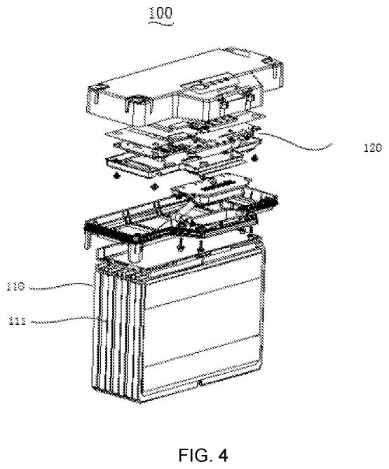

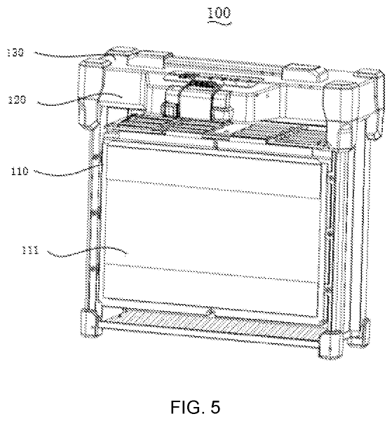

In some exemplary embodiments of the present disclosure, the external device described may be an unmanned aerial vehicle. In some exemplary embodiments of the present disclosure, the unmanned aerial vehicle may be an unmanned aerial vehicle with fixed rotors, or a multi-motor unmanned aerial vehicle. When the external device is an unmanned aerial vehicle, the intelligent battery 100, as a power supply device for the unmanned aerial vehicle, provides power required for flight of the unmanned aerial vehicle. The intelligent battery may be generally disposed on a main body of the unmanned aerial vehicle, and may establish an electrical connection and a communication connection to the unmanned aerial vehicle. Referring to FIG. 4, in some exemplary embodiments of the present disclosure, the intelligent battery 100 may include a cell assembly 110 and a battery management system 120. In some exemplary embodiments of the present disclosure, a physical form of the battery management system 120 may be a battery protection board covering the cell assembly 110, as shown in FIG. 4. Further referring to FIG. 5, the cell assembly 110 and the battery protection board may be combined, and together may form a complete intelligent battery 100 with an external packaging component. In this case, the intelligent battery 100 may be placed directly on the main body of the unmanned aerial vehicle to supply power to the unmanned aerial vehicle. When the intelligent battery 110 is placed on the unmanned aerial vehicle, the unmanned aerial vehicle may identify the intelligent battery and identify whether the intelligent battery 110 may be matchable and usable with the unmanned aerial vehicle. In some exemplary embodiments of the present disclosure, the encryption circuit 112 may be disposed on the cell assembly of the intelligent battery 100. The encryption circuit 112 may be an encryption chip. The encryption chip may be directly embedded in the cell assembly 110. Further, the encryption chip may be embedded in the at least one tab plate electrically connected to the cell body, so that the encryption chip may be indirectly coupled to the cell body 111. The encryption chip may be communicatively connected to the battery management system 120 in a two-wire serial bus connection mode. The encryption chip may send the feature information of the cell body 111 to the battery management system 120. Further, the battery management system 120 forwards the received feature information of the cell body 111 to the unmanned aerial vehicle, and in some exemplary embodiments of the present disclosure, forwards the feature information to a flight control system of the unmanned aerial vehicle for authentication. If the authentication succeeds, it proves that the intelligent battery may be matchable with the unmanned aerial vehicle and may be used normally. If the authentication fails, it proves that the intelligent battery may not be matchable with the unmanned aerial vehicle and may not supply power to the unmanned aerial vehicle normally. In this case, the unmanned aerial vehicle may not perform a normal operation.

In some exemplary embodiments of the present disclosure, the battery management system 120 may further include an alarm device. When the intelligent battery 100 may not be matchable and usable with the external device, the alarm device may send an alert to alert a user that the intelligent battery may have some problems, which will affect safety of the external device in use. In some exemplary embodiments of the present disclosure, an alarm form of the alarm device may include a voice alert, a light alert, a vibration alert, or the like, or any combination thereof. All forms that may alert the user may be included, and there is no excessive limitation herein. Further, the alarm device may include a speaker, a buzzer, a lamp, a vibrator, or the like, or any combination thereof, to implement different alarm forms.

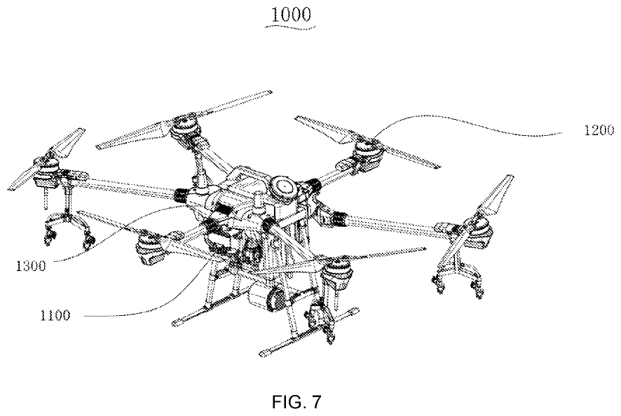

In some exemplary embodiments of the present disclosure, referring to FIG. 7, an unmanned aerial vehicle 1000 is provided. The unmanned aerial vehicle 1000 may include a propulsion system 1200, a main body 1300, and the intelligent battery 1100 in some exemplary embodiments of the present disclosure disposed in the main body 1300.

In some exemplary embodiments of the present disclosure referring to FIG. 7, the propulsion system 1200 may be mounted on the main body 1300 to supply power to the unmanned aerial vehicle 1000 for flying. The intelligent battery 1100 may also be mounted on the main body 1300 and may be electrically connected to the propulsion system 1200 to supply power to the propulsion system 1200.

In some exemplary embodiments of the present disclosure, the unmanned aerial vehicle 1000 may further include an alarm device, where the alarm device may indicate whether a cell assembly 1110 in the intelligent battery 1100 may be matchable and usable with the unmanned aerial vehicle 1000. If the cell assembly 1110 is matchable and usable, the alarm device does not send any alert. If the cell assembly 1110 is not be matchable and usable, the alarm device starts an alarm to alert a user. The alarm device may have a plurality of alarm forms including at least one of: a voice alert, a light alert, or a vibration alert. Further, to implement the foregoing alarm form, the alarm device may be at least one of a speaker, a buzzer, a lamp, or a vibrator. Details are not specifically limited herein.

In some exemplary embodiments of the present disclosure, the unmanned aerial vehicle may be an agricultural unmanned aerial vehicle. As shown in FIG. 7, the agricultural unmanned aerial vehicle 1000 may include a propulsion system 1200, a main body 1300, and an intelligent battery 1100 that provides power. The propulsion system 1200 may further include a plurality of power components such as motors and rotors. In addition to the intelligent battery 1100, the main body 1300 may also contain a tank, where the tank may contain water, pesticide, seeds, powder, and the like for spraying. Because batteries used in agricultural unmanned aerial vehicles are mostly high-voltage and large-capacity batteries having a plurality of cells connected in series or in parallel, it may be necessary to match and authenticate the batteries matched and used with the unmanned aerial vehicles to prevent accidents due to the use of counterfeit batteries.

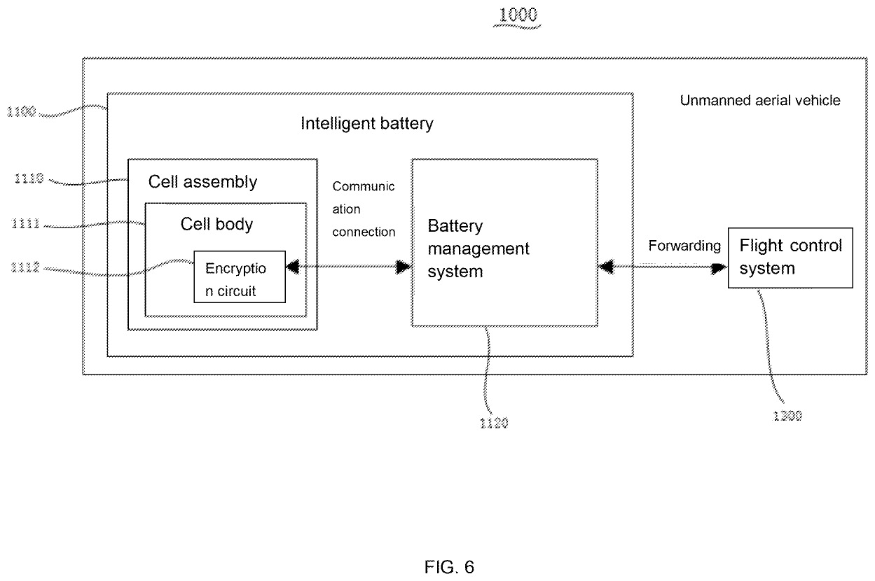

In some exemplary embodiments of the present disclosure, the intelligent battery 1100 may be disposed on the main body 1300 as a power supply device for the agricultural unmanned aerial vehicle 1000, and may establish an electrical connection and a communication connection to the agricultural unmanned aerial vehicle 1000. In some exemplary embodiments of the present disclosure with reference to FIG. 6, the intelligent battery 1100 may include a cell assembly 1110 and a battery management system 1120. When the intelligent battery 1110 is placed on the main body 1300, the agricultural unmanned aerial vehicle 1000 may identify the intelligent battery and identify whether the intelligent battery 1110 may be matchable and usable with the unmanned aerial vehicle 1000. In some exemplary embodiments of the present disclosure, an encryption circuit 1112 may be disposed on the cell assembly 1110 of the intelligent battery 1100. The encryption circuit 1112 may be an encryption chip. The encryption chip may be directly embedded in the cell assembly 1110. Still further, the encryption chip may be embedded in at least one tab plate electrically connected to a cell body 1111, so that the encryption chip may be indirectly coupled to the cell body 1111. The encryption chip may be communicatively connected to the battery management system 1120 in a two-wire serial bus connection mode. The encryption chip may send feature information of the cell body 1111 to the battery management system 1120. Further, the battery management system 1120 may forward the received feature information of the cell body 1111 to the agricultural unmanned aerial vehicle 1000, and in some exemplary embodiments of the present disclosure, forwards the feature information to a flight control system of the agricultural unmanned aerial vehicle 1000 for authentication. If the authentication succeeds, it proves that the intelligent battery may be matched with the unmanned aerial vehicle and may be used normally. If the authentication fails, the alarm device sends a corresponding alert, and it proves that the intelligent battery may not be matched with the agricultural unmanned aerial vehicle 1000. In this case, the intelligent battery may not supply power to the agricultural unmanned aerial vehicle normally, and the agricultural unmanned aerial vehicle 1000 may not take off normally or perform another operation.

It should be noted that the relational terms such as first and second in this disclosure are used only to differentiate an entity or operation from another entity or operation, and do not require or imply any actual relationship or sequence between these entities or operations. The terms “comprising”, “including”, or any other variants thereof are intended to cover a non-exclusive inclusion, so that a process, a method, an article, or a device that includes a list of elements not only includes those elements but also includes other elements that are not expressly listed, or further includes elements inherent to the process, method, article, or device. In absence of more constraints, an element preceded by “includes a . . . ” does not preclude existence of other identical elements in the process, method, article, or device that includes the element.

The cell assembly, intelligent battery, and unmanned aerial vehicle in some exemplary embodiments of the present disclosure are described in detail above. The principles and implementations of the present disclosure are described herein by using some non-limiting examples. The description of the exemplary embodiments is merely provided to help understand the method and core idea of the present disclosure. In addition, a person of ordinary skill in the art can make variations and modifications to the present disclosure in terms of the specific implementations and application scopes according to the idea of the present disclosure. Therefore, content of this disclosure shall not be construed as limiting.

What is claimed is:

1. A cell assembly, comprising:
at least one cell body; and
at least one encryption circuit storing feature information of the at least one cell body and directly or indirectly coupled to the at least one cell body to form an independent unit, wherein
the independent unit is mechanically and detachably connectable to an external device, and
when the independent unit is electrically connected to the external device, the at least one encryption circuit is configured to send the feature information of the at least one cell body to the external device, to determine whether the at least one cell assembly is matchable and useable with the external device.

2. The cell assembly according to claim 1, further comprising:
at least one tab plate electrically connected to the at least one cell body, wherein the at least one cell body supplies power to the external device through the at least one tab plate.

3. The cell assembly according to claim 2, wherein the at least one encryption circuit is electrically connected to the at least one tab plate, the at least one encryption circuit sends the feature information of the at least one cell body to the external device through the at least one tab plate.

4. The cell assembly according to claim 2, wherein the at least one encryption circuit is disposed on the at least one tab plate.

5. The cell assembly according to claim 1, wherein the at least one encryption circuit is disposed on the at least one cell body.

6. The cell assembly according to claim 5, wherein the at least one encryption circuit is disposed in the at least one cell body.

7. The cell assembly according to claim 5, wherein the at least one encryption circuit is disposed on a surface of the at least one cell body.

8. The cell assembly according to claim 1, wherein a quantity of the at least one encryption circuit is the same as a quantity of the cell assembly so that one encryption circuit is disposed on each cell assembly; or
a quantity of at least one encryption circuit is the same as a quantity of the at least one cell body, so that one encryption circuit is disposed on each cell body.

9. The cell assembly according to claim 1, wherein the at least one encryption circuit includes at least one of: an encryption chip or a micro control unit supporting an encryption algorithm.

10. The cell assembly according to claim 9, wherein the at least one encryption chip is communicatively connectable to the external device.

11. The cell assembly according to claim 1, wherein the feature information includes at least one of:
asymmetric encryption information or symmetric encryption information.

12. The cell assembly according to claim 1, wherein the feature information includes electrical parameter information of the at least one cell body.

13. The cell assembly according to claim 12, wherein the electrical parameter information include at least one of: a full charging voltage, a full charging capacity, a quantity of cycles, a platform voltage, a pack manufacturer, or a running status parameter.

14. The cell assembly according to claim 1, wherein a connection mode of the at least one cell body includes at least one of:
a series connection, a parallel connection, or a series-parallel connection.

15. The cell assembly according to claim 1, wherein the cell assembly further includes:
a covering part, wherein the at least one cell body and the at least one encryption circuit are mounted in the covering part.

16. The cell assembly according to claim 15, wherein the covering part is a hard housing or a soft bag.

17. The cell assembly according to claim 1, wherein the cell assembly further includes:
an electrical connection interface, wherein the cell assembly is electrically connected to the external device via the electrical connection interface.

18. The cell assembly according to claim 1, wherein the external device is at least one of: a battery management system (BMS) or an unmanned aerial vehicle.

19. An intelligent battery, comprising:
a housing;
a battery management system mounted in the housing; and
a cell assembly mounted in the housing, including:
at least one cell body, and
at least one encryption circuit storing feature information of the cell body and directly or indirectly coupled to the at least one cell body to form an independent unit, wherein
the independent unit is mechanically and detachably connectable to the battery management system;
when the independent unit is electrically connected to the battery management system, the battery management system is communicatively connectable to both the at least one encryption circuit and an external device, and the at least one encryption circuit is configured to send the feature information of the at least one cell body to the external device to perform communication authentication for the cell assembly, to determine whether the cell assembly is matchable and usable with the external device.

20. An unmanned aerial vehicle, comprising:
a main body;
a propulsion system, mounted on the main body to supply power to the unmanned aerial vehicle; and
an intelligent battery disposed in the main body, including:
a housing;
a battery management system mounted in the housing; and
a cell assembly mounted in the housing, including:
at least one cell body, and
at least one encryption circuit storing feature information of the cell body and directly or indirectly coupled to the at least one cell body to form an independent unit, wherein
the independent unit is mechanically and detachably connectable to the battery management system;
when the independent unit is electrically connected to the battery management system, the battery management system is communicatively connectable to both the at least one encryption circuit and an external device, and the at least one encryption circuit is configured to send the feature information of the at least one cell body to the external device to perform communication authentication for the cell assembly, to determine whether the cell assembly is matchable and usable with the external device;
wherein the intelligent battery is electrically connected to the propulsion system to supply power to the propulsion system.
